(19) United States
(12) Patent Application Publication
(10) Pub. No.: US 2023/0303334 A1
(43) Pub. Date: Sep. 28, 2023

(54) Bulk Material Belt Conveyor and Idler Assemblies for A Bulk Material Belt Conveyor

(71) Applicants: Eduard Batko, Buffalo Grove, IL (US); James D. Schwarz, Elmhurst, IL (US); Aleksander Sergeevich Sergeev, Vologda (RU)

(72) Inventors: Eduard Batko, Buffalo Grove, IL (US); James D. Schwarz, Elmhurst, IL (US); Aleksander Sergeevich Sergeev, Vologda (RU)

(21) Appl. No.: 17/702,211

(22) Filed: Mar. 23, 2022

(51) Int. Cl. B65G 39/09; B65G 39/12

(52) U.S. Cl. CPC B65G 39/09; B65G 39/12

(57) ABSTRACT

A troughing idler assembly for a bulk material belt conveyor is disclosed having a frame, at least four axles, and at least four wheels. The axles are mounted to the frame, each of the axles extending in a common plane or at least one plane transverse to a conveying direction. Each wheel is mounted to a corresponding axle. The wheels are arranged in a trough configuration where at least two outer wheels of are positioned vertically higher than at least one inner wheel. A return idler assembly for a bulk material belt conveyor is disclosed having an axle and a plurality of wheels. A bulk material belt conveyor is disclosed having the troughing idler assembly and/or the return idler assembly.

### FIELD OF THE INVENTION

This invention relates in general to bulk material belt conveyors.

### BACKGROUND

Bulk material belt conveyors convey bulk material on a belt.

U.S. Pat. No. 2,592,831 discloses a conveyor mechanism with a single roll return idler and three troughing rolls mounted in a troughing idler frame. U.S. Pat. No. 3,217,862 discloses a stand having a roll assembly which includes three idler rolls.

Some three roll troughing idlers and single roll return idlers each suffer from disadvantages, such as: (a) When a roll seizes and does not rotate, the belt slides over the seized roll and rubs the wall of the roll, which may form an edge on the roll. The belt then rubs against the formed edge leading to the destruction of the belt. (b) The rolls comprise an elongated surface providing a greater surface area on which debris and material can accumulate, which may increase the likelihood that debris and/or material buildup on the roll may cause lateral diversion or mis-training of the belt from its normal operating location or path.

Some three roll troughing idlers suffer from further disadvantages, such as: (a) The rolls, as positioned, lack the option to provide additional control at the lateral edges of the belt to prevent material from spilling off the side of the belt for certain volumes of bulk material. (b) The rolls comprise an elongated surface and therefore contribute to longer flatter profiles along the trough without the option to provide additional curvature or depth to the trough.

### SUMMARY

According to an embodiment, a troughing idler assembly for a bulk material belt conveyor is disclosed comprising a frame, at least four axles, and at least four wheels. The axles mounted to the frame, each of the axles extending in a common plane or at least one plane transverse to a conveying direction. Each wheel comprising a wheel bearing. Each wheel mounted to a corresponding axle. The wheels are arranged in a trough configuration where at least two outer wheels of are positioned vertically higher than at least one inner wheel.

According to an embodiment, a return idler assembly for a bulk material belt conveyor is disclosed comprising an axle and a plurality of wheels. Each of the plurality of wheels are aligned co-axially in a row, comprise a bearing, and are mounted to rotate independently on the axle. In some embodiments, a first pair of wheels at a first end of the axle are spaced closer together than at least one other pair of wheels. In some embodiments, a second pair of wheels at a second end of the axle are spaced closer together on the axle than the at least one other pair of wheels.

According to an embodiment, a bulk material belt conveyor is disclosed comprising the troughing idler assembly and/or the return idler assembly. The conveyor comprises a belt and a conveyor frame. The belt is supported on the wheels of troughing idler assembly and/or the wheels of the return idler assembly.

In some embodiments, the troughing idler assembly and the return idler assembly are mounted to the conveyor frame. The troughing idler assembly mounted above the return idler assembly. The belt is supported on the wheels of troughing idler assembly and the wheels of the return idler assembly.

Numerous other advantages and features of the present invention will become readily apparent from the following detailed description of the invention and the embodiments thereof, from the claims, and from the accompanying drawings.

### BRIEF DESCRIPTION OF THE DRAWINGS

FIG. 1 is a perspective view of a portion of an embodiment of bulk material belt conveyor comprising embodiments of idler assemblies.

FIG. 2 is an enlarged perspective view of a portion of the bulk material belt conveyor of FIG. 1.

FIG. 3 is a front view of a trough idler assembly of FIG. 1.

FIG. 4 is a front view of the trough idler assembly of FIG. 3 supporting a conveyor belt.

FIG. 5 is a side view of the trough idler assembly of FIG. 3.

FIG. 6 is a side sectional view of a wheel mounted on an axle of the trough idler assembly of FIG. 3 taken along the plane 5-5 of FIG. 3.

FIG. 7 is a bottom view of a foot of the trough idler assembly of FIG. 3.

FIG. 8 is a front view of a first embodiment return idler assembly of FIG. 1.

FIG. 9 is a top view of the return idler assembly of FIG. 8.

FIG. 10 is a front view of the return idler assembly of FIG. 8 carrying a conveyor belt.

FIG. 11 is a side section view of a wheel mounted on an axle of the return idler assembly of FIG. 8, where the axle is not shown in section.

FIG. 12 is a front view of a second embodiment return idler assembly.

FIG. 13 is a top view of the second embodiment return idler assembly of FIG. 13.

FIG. 14 is a side section view of a wheel mounted on an axle of the return idler assembly of FIG. 12 with spacers.

FIG. 15 is a front view of a third embodiment return idler assembly.

FIG. 16 is a top view of the third embodiment return idler assembly of FIG. 15.

### DETAILED DESCRIPTION

The following description is presented to enable any person skilled in the art to make and use the invention. For the purposes of explanation, specific nomenclature is set forth to provide a plural understanding of the present invention. While this invention is susceptible of embodiment in many different forms, this description describes and the drawings show specific embodiments of the invention with the understanding that the present disclosure is to be considered as an exemplification of the principles of the invention and is not intended to limit the invention to the specific embodiments illustrated.

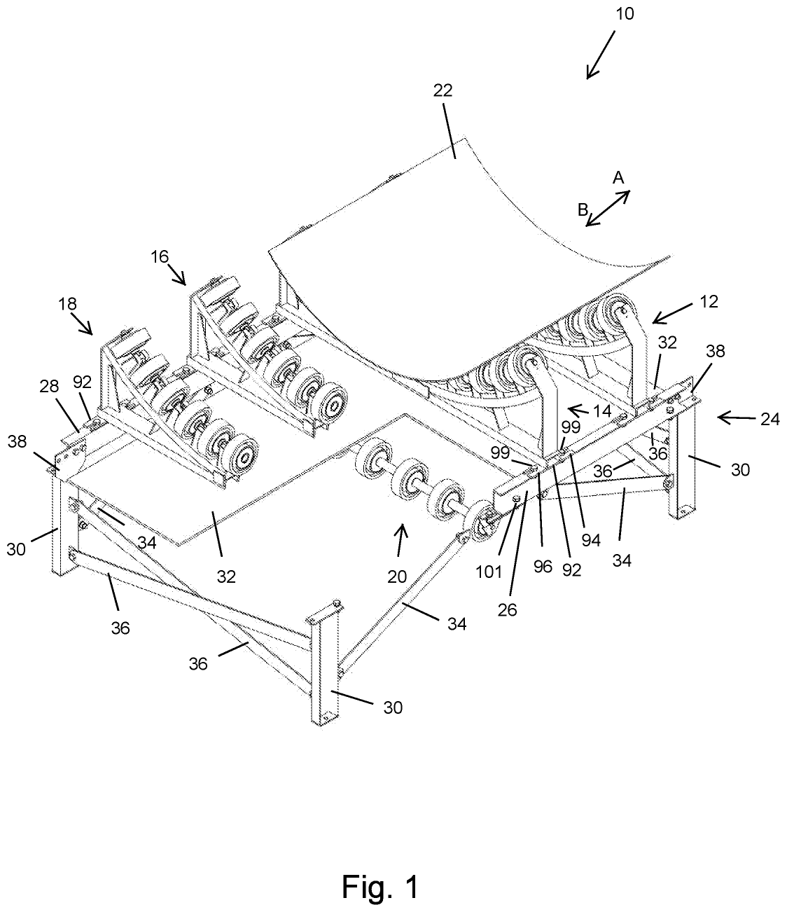

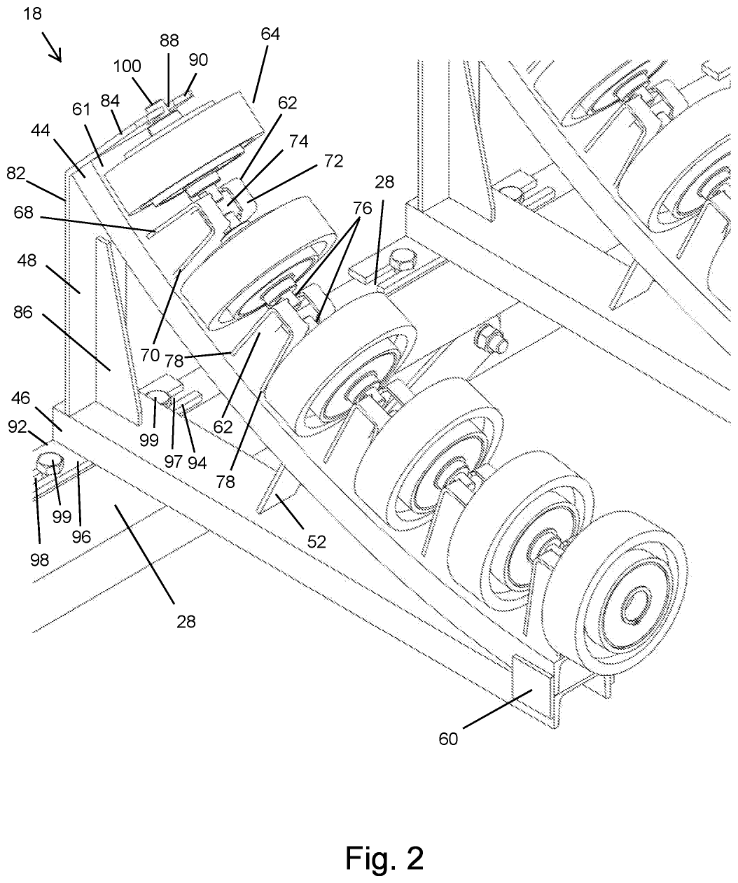

FIG. 1 shows an embodiment of a portion of a bulk material belt conveyor 10 comprising troughing idler assemblies 12, 14, 16, 18, a return idler assembly 20, a belt 22, and a conveyor frame 24. Troughing idler assemblies 12, 14, 16, and 18 are identical. Troughing idler assemblies 16, 18 are only partially shown in FIGS. 1 and 2 to allow for a cut-away view where the return idler assembly 20 is visible below in FIG. 1.

The conveyor frame 24 comprises a first side rail 26, a second side rail 28, and a plurality of legs 30 (fourth leg not shown). In some embodiments, the frame comprises a plate or surface 32, side braces 34, and/or cross braces, 36. The side braces and cross braces may connect the legs to a one or more side rails as shown in FIG. 1. The side braces and the cross braces may be arranged in a cross or X-configuration as is shown with cross braces 36. The side braces and cross braces may be connected to the legs and/or rails with fasteners, such as bolts and nuts, screws, by welding, or by other means of attachment. The legs 30 may be connected to the respective side rails 26, 28 by a bracket, such as an L-bracket 38. The legs 30 may be connected to the bracket and/or the siderails by fasteners, bolts and nuts, screws, by welding, or by other means of attachment. Rail 26 is partially shown in FIG. 1 to allow for the cut-away view and the view of the return idler assembly 20. The rail 26 extends to the forward most leg 30 of FIG. 1.

The troughing idler assemblies 12, 14, 16, 18 are supported on opposite sides by the side rails 26, 28. Similarly, the return idler assembly 20 is supported on opposite sides by the side rails 26, 28. In some embodiments, the side rails comprise an angular C-shape as shown in FIG. 1, with an upper horizontal portion, a vertical portion, and a lower horizontal portion. Other side rail shapes are possible.

While one return idler assembly is shown in FIG. 1, any number of return idler assemblies can be used. For example, return idler assemblies can be mounted to the rails at each of the locations along the longitudinal length A/B of the conveyor where the troughing idler assemblies are located. Any number of troughing idler assemblies and return idler assemblies can be used, as the application may require or as desired, along the longitudinal length 40 of the conveyor. The number of troughing idler assemblies and return idler assemblies, may be, but need not be the same. Further, the length of the conveyor 10 may be extended in either or both directions A and B and may be of any desired length.

The belt 22 is partially shown in FIG. 1. The belt is supported by the troughing idler assemblies above the rails 26, 28. The belt is supported on top of the return idler assemblies at or below the rails 26, 28. The belt is typically continuous or endless and at the end of the conveyor the belt extends and loops from being supported by the troughing idler assemblies to being supported by the return idler assemblies. At the end of a return path, the belt extends and loops up from support by the return idler assemblies to being supported by the troughing idler assemblies. Therefore, the belt operates in a continuous loop along the conveyor 10. Bulk material, such as sand, gravel, limestone, granite, iron ore, and/or coal, can be placed on the belt and moved along the conveyor by the belt supported by the troughing idler assemblies. A motor (not shown) drives the belt forward in the direction B or A when on the troughing idler assemblies and in the opposite direction when on the return idler assemblies. In this manner, bulk material on the belt can be moved along the conveyor in the desired direction.

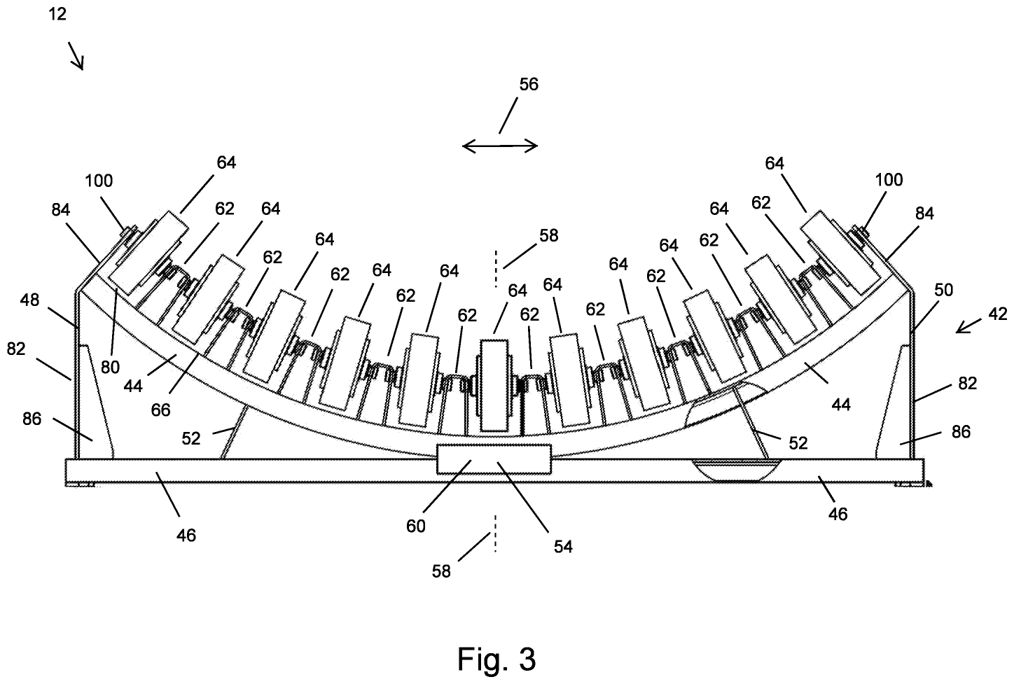

FIGS. 2, 3, and 4 show the troughing idler assemblies in more detail. Since troughing idler assemblies 12, 14, 16, 18 are identical, only assembly 12 will be described in detail. Troughing idler assembly 12 comprises a trough frame 42. The trough frame 42 comprises an arc member 44 and a base member 46. The trough frame comprises end members or plates 48, 50 that support the arc member above the base member. In some embodiment, the trough frame comprises intermediate vertical supports 52. In some embodiments, the arc member meets or is joined to the base member at middle/center 54 or midplane 58 of the width 56 of the troughing idler assembly, base member, and/or arc member. A joining plate 60 may be fixed to each of the arc member and the base member at the middle 54 as shown in FIG. 3. The joining plate may be fixed by welding or fasteners, or other means.

The top side of the arc member 44 comprises a plurality of posts 62 supporting a plurality of wheels 64. Each of the posts 62 are fixed to an upper surface 66 of the arc member 44. As labeled in FIG. 2, each post 62 comprises a first leg 68, a second leg 70, and a top wall 72 connecting the first and second legs. The top wall 72 has an aperture 74. The first leg 68 has an aperture 76, and the second leg 70 has an aperture 76. The aperture of the top wall is in communication and open to the apertures 76 of each of the first and second legs. In some embodiments, the first and second legs converge toward each other from a base 78 of the first and second legs toward the top wall. The apertures 76 in the legs are sized to receive axles of the wheels as shown in at least FIGS. 1-3. The aperture in the top wall is sized to allow the axles 100 supporting the wheels to pass the top wall and be received into or removed from the apertures of the legs. The location of the apertures and the circumference of the wheels are such that the wheel does not contact the upper surface 61 of the arc member 44 when the axle 100 is supported on the legs within the leg apertures of the posts, for example, as shown in FIG. 3. A gap 80 is located between the wheels 64 and the upper surface 61 of the arc member 44.

Each of the end plates 48, 50 comprise a vertical portion 82 and an end portion 84. The bottom of the vertical portion 82 is fixed to the base member 46. Gussets 86 may be provided connected at right angles to the vertical portion 82 and the base member 46 to strengthen the connection of the vertical portion to the base member and provide additional rigidity. The Gussets 86 may be triangular or substantially triangular as shown in FIG. 2. The end portion is angled toward the center 54. In some embodiments, the end portion 84 is angled at any position of the range of zero degrees to 50 degrees from the vertical portion 82. The end portion 84 has an axle aperture 88 open to a top 90 of the vertical portion. The outer terminal end of the axles 100 of the outer wheels 64b, 64c are supported by the vertical portion within the respective aperture 88 of the respective end plates 48, 50 as shown in FIGS. 1, 2, 3, and 4.

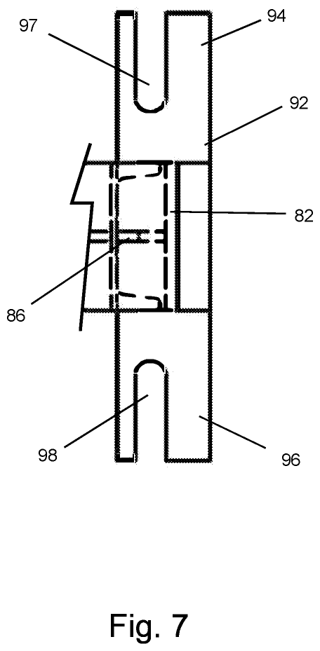

As shown in FIGS. 1, 2, 3, 4, and 7, feet 92 are fixed to the base member 46 at opposite sides of the base member below the end plates 48, 50. A first side and a second side 94, 96 of the feet each comprise apertures 97, 98. Fasteners, such as bolts 99, are used at the apertures 97, 98 to fix the feet to the respective rail 26, 28 and therefore the troughing idler assembly to the rail 26, 28. The head of the bolts 99 bear against the respective first or second side 94, 96 about the aperture 97, 98, the shank of the bolt extends through the aperture and is threaded into the rail or a nut threaded on the shank opposite the head and bears against an opposite side of the rail or rail portion.

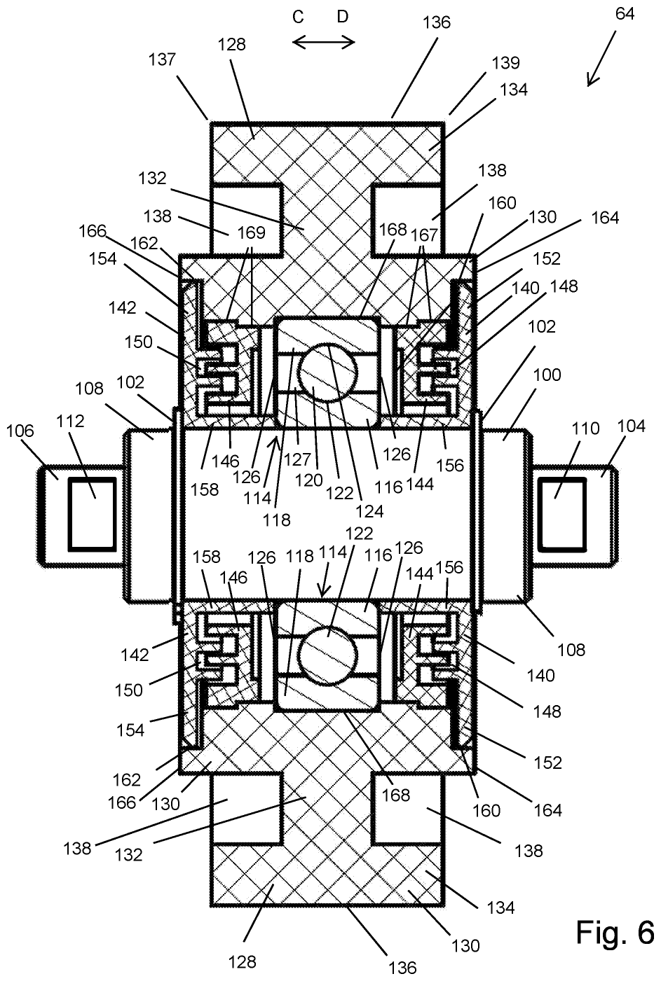

FIG. 6 shows a side view of an axle 100 and retaining clips 102, and a cross-section of a wheel 64. The wheel 64 is mounted to an axle 100. The wheel is held laterally C/D in place on the axle by the retaining clips 102. The retaining clips 102 are received in grooves (not shown) in the axle and abut the wheel. The clips and grooves completely or partially encircle the axle. The axle comprises mount terminal ends 104, 106. The mount ends 104, 106 comprise a circumference that is reduced from a circumference of the main body 108 of the axles.

The end 104 comprises two mounting slots 110 on opposite sides of the end (only one mounting slot 110 is visible in FIG. 6). The end 106 comprises two mounting slots 110 on opposite sides of the end (only one mounting slot 112 is visible in FIG. 6). The slots 110, 112, are recessed from the outer surface of the ends 104. In some embodiments, the ends 104, 106 are cylindrical outside of the slots 110, 112. In some embodiment, the slots have flat or planar bottom surfaces. The slots 110, 112 receive side portions of the legs 68, 70 of the posts 62 at the respective aperture 76 to mount the axle to the post and therefore the wheel to the post, as shown in FIG. 2. The side portions of the legs about the aperture 76 engage with the slots to prevent the axles from rotating relative to the posts, or to prevent rotation beyond a predefined tolerance allowed by the tolerance interface between the side portions of the legs about the aperture 76 and the slots of the axles. Therefore, the axles are fixed or substantially fixed against rotation relative to the post. In some embodiments, the side portions of the legs about the aperture 76 and the slots are both flat for mating with each other.

The wheel 64 comprises a bearing 114, the bearing surrounds and interfaces with the axle. The bearing transfers the load applied to the wheel to the axle. In some embodiments, the bearing 114 comprises an inner race 116, outer race 118, and a plurality of balls 120 between the inner race and the outer race. The inner race is supported on the axle. The inner race comprises a ball valley 122 and the outer race 118 comprises a ball valley 124. The plurality of balls 120 are within the ball valleys 122, 124 of the bearing. The balls are rollable within the valleys to allow the outer race to rotate about the shaft relative to the inner race and the shaft. Side bearing seals 126 enclose opposite sides of the space 127 about the balls within the bearing.

The wheel 64 comprises a tire 128 mounted on the bearing, and in particular at least on the outer race of the bearing. In some embodiments, the tire may comprise or be formed of one or more of nylon, polyamine, polyamine 6, steel, and/or rubber. The tire can be completely solid, partially solid, or hollow. In some embodiments, the tire 128 comprises an inner support portion 130, a bridge portion 132, and an outer portion 134. The outer portion 134 comprises the belt receiving surface 136. The surface 136 engages and supports the belt when in contact with the belt. In some embodiments, surface 136 is cylindrical between outside edges 137, 139 about the axle 100, and in particular, cylindrical of a right circular cylinder. In some embodiments, the width of the surface 126 between outside edges 137, 139 is a width in the range of about 1.75 inches (or 45 millimeters (mm)) to about 5 inches (or 127 mm), and in one example about 47 mm. In some embodiments, the wheel has a diameter from a center of the wheel to the surface 136 of about 159 mm.

In some embodiments, there are recess regions 138 adjacent and on opposite sides of the bridge portion 132 and between the inner support portion 130 and outer portion 134 as shown in FIG. 6.

The wheel comprises outer seals 140, 142 and inner seals 144, 146. The outer and inner seals 140, 144 form a labyrinth 148, the outer and inner seals 142, 146 form a labyrinth 150. In some embodiments the inner seals 144, 146 comprise an E-shape as shown in FIG. 6, and the outer seals comprise an F-shape, as shown in FIG. 6. The prongs of the F-shape are located between the prongs of the E-shape to form the labyrinth, which is a path between the inner seal and the outer seal. The labyrinth reduces the amount of exterior contaminants that can get into the wheel, to the axles, and to the bearing, thereby extending their life.

The outer seals 140, 142 comprise a peripheral wall 152, 154 and an axle facing wall 156, 158. The peripheral wall 152, 154 is connected and transverse to the respective axle facing wall 156, 158. The axel facing walls 156, 158 terminate at the bearing 114 opposite of the respective peripheral wall 152, 154.

The inner support portion 130 of the tire comprises outer insets 160, 162 that allow the outer seals to be received within the circumference of the inner support portion 130 of the tire. The insets 160, 162 allow the outer face of the outer seal 140, 142 to be aligned with or substantially aligned with the respective outer face 164, 166 of the inner support portion 130. The inset position of the outer seals relative to the inner support portion reduces the chance that contaminates will enter the labyrinths 148, 150.

The inner support portion comprises bearing recess 168, the sides of which partially surround the bearing to maintain its lateral position. The inner support portion comprises inner seal steps 167, 169 that receive conforming steps of the inner seal a shown in FIG. 6. The wheel rotates about the axle on the bearing, the bearing is protected from outside contaminants by the inner and outer seals. The axel occupies the axis of rotation of the wheel.

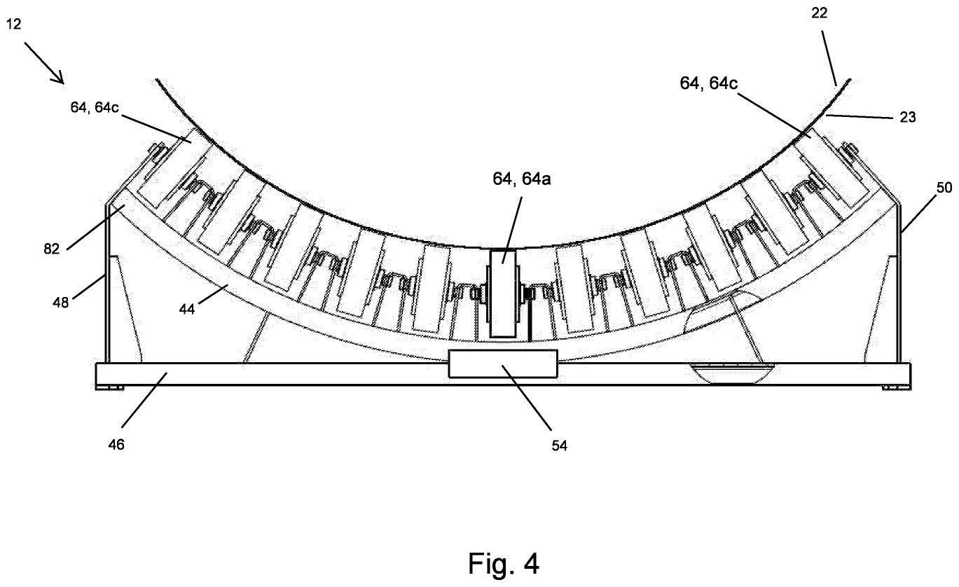

The wheels 64 are arranged is a trough configuration or as a wheel trough where at least two outer wheels are positioned vertically higher than at least one inner wheel. FIGS. 3 and 4 show that the arc member 44 positions the axles and the wheels so that they are in a trough configuration or as a wheel trough. The posts 62 position the axles and the wheels so that the wheels are positioned along a trough path or arc to form a wheel trough for supporting the belt 22. The tough path or arc may be the path or arc of the belt 22 shown in FIG. 4. While the trough path is shown as a generally curved path, other trough shapes are possible that comprise a width 56 with raised outsides.

The surface 136 of each of the wheels, at the top of the wheels, contacts the bottom 23 of the belt 22 at multiple locations and supports the belt in a trough shape or configuration as shown in FIG. 4. The wheel trough is shown discontinuous, where the belt 22 bridges the gaps between adjacent wheels along the width 56 of the trough idler assembly.

In some embodiments, each successive wheel proceeding from the center wheel 64a (FIG. 4) in each direction along the width 56 is positioned vertically higher than the preceding wheel, as can be seen in FIGS. 3 and 4. Therefore the center wheel 64a is positioned vertically lowest as compared to the other wheels. While only one center wheel 64a is shown at the lowest vertical position in the figures, in some embodiments, more than one wheel is at the lowest vertical position. Further, the lowest vertically positioned wheel could be a non-center wheel.

In some embodiments, for at least one less than the total number of axles: the first terminal end 104 or 106 of the axle that is further from a center 54 of the frame is positioned vertically higher than the opposite second terminal end 104 or 106 that is closer to the center 54. Therefore, proceeding from the center wheel 64a in each direction along the width 56, the outside terminal end of the axle is positioned higher than the inside terminal end of the axle, and each axle is angled upward toward respective end portion 84 of end plate 48, 50 on the given side of center wheel 64a, thereby contributing the shape of the trough configuration of the wheels.

In some embodiments, the center wheel, 64a (FIG. 4) has an axle and an axis of rotation that is horizontal and where the opposite terminal ends of the axle are level. In some embodiments, the center wheel is not level or horizontal and one or the other of the terminal ends 104, 106 of the axle of the center wheel is vertically higher than the other.

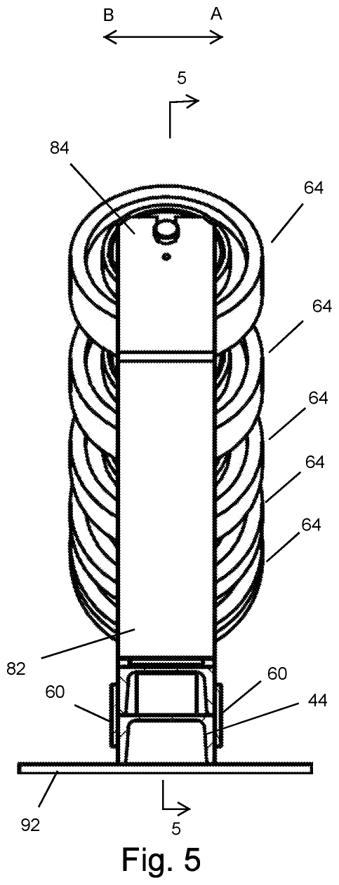

The wheels 64 each rotate independently of the other wheels. In some embodiments, the axis of rotation of each wheel and each axle of the troughing idler assembly 12 resides in common plane, such as indicated by the alignment of wheels shown in FIG. 5. Therefore, the wheels can be positioned in an aligned row, along the trough arc or path, as shown in FIGS. 4 and 5. In some embodiments, the axis of rotation of each wheel and each axle of the troughing idler assembly 12 resides in common plane or at least one plane that is transverse the longitudinal conveying path or direction A/B of the conveyor and belt. The wheels may be free to rotate in either direction and therefore rotate clockwise or counterclockwise about the respective axle. In practice, the wheel will rotate as driven by the movement of the belt in connect with the wheels.

In some embodiments, when the tire of the wheel has cylindrical belt receiving surface 136, the surface 136 of each of the wheels, at the top of each wheel, is tangent to a trough arc extending between the outer most wheels and occupied by the belt. However, the belt may rest fully on the width of the surface 136 of each wheel or some wheels when unloaded or loaded.

In some embodiments, the plurality of wheels of the troughing idler assembly comprise at least 4 wheels, or at least 5 wheels, or at least any number of wheels 64 in the range of 5 wheels to 22 wheels, or more wheels. FIGS. 3 and 4 show the troughing idler assembly with 11 wheels.

In some embodiments, the trough arc or path along which the wheels are located extends 20 or 35 or 45 or 50 degrees in each lateral direction 56 from the center 54 or mid-plane 58 intersecting the middle wheel 64a. In some embodiments, the trough arc or path along which the wheels are located extends between and including about 20 and about 50 degrees in each lateral direction 56 from the center 54 or mid-plane 58 intersecting the middle wheel 64a. In some embodiments, the wheels are spaced apart equally along the width 56 of the assembly, as shown in FIGS. 3 and 4.

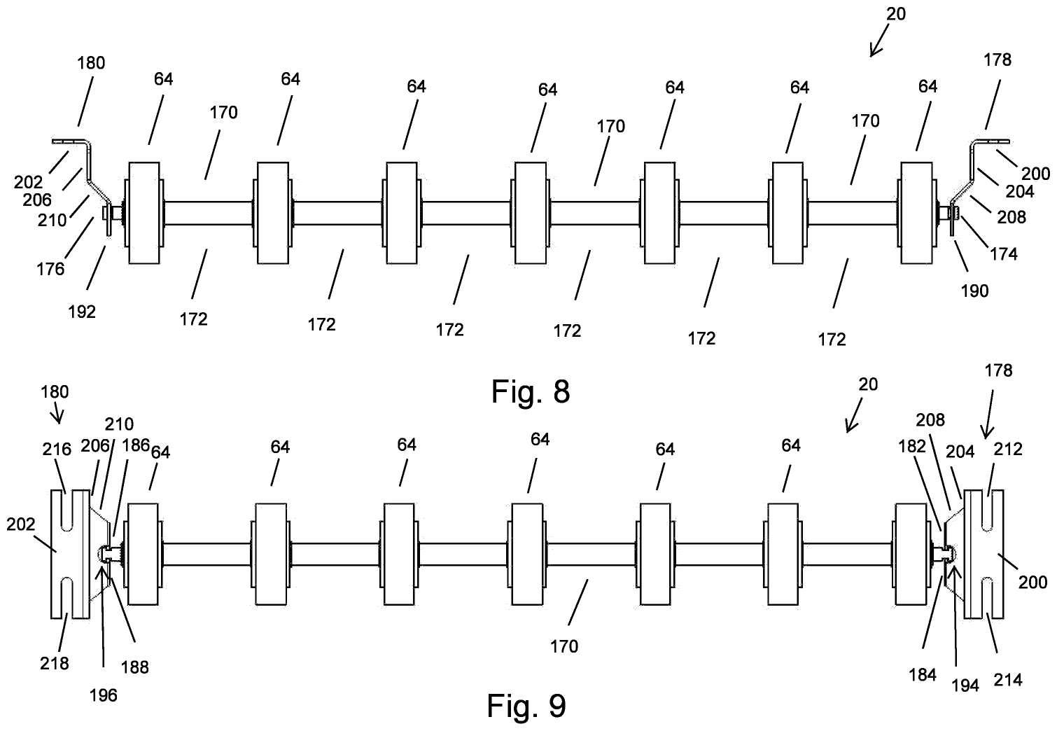

FIGS. 8 and 9 show a first embodiment return idler assembly 20. The assembly comprises a plurality of wheels 64, which are the same as the wheels of troughing idler assembly 12, except the wheels 64 are mounted to axle 170 rather than axle 100. Each of the wheels 64 rotates independently of the other wheels on and about the axle 170. The wheels are co-axial with each other and aligned in a row along the axle 170. The wheels 64 are spaced apart by a plurality of interspaced gaps 172 along the axle 170. In some embodiments, the return idler assembly comprises comprise at least 4 wheels, or at least 5 wheels, or at least any number of wheels 64 in the range of 5 wheels to 22 wheels or more wheels along the axle 170. FIGS. 8 and 9 show the return idler assembly with 7 wheels.

The axle 170 comprise mount terminal ends 174, 176 that are the same as the mount terminal ends 104, 106 of axles 100 including the slots 110, 112. The slots of the terminal ends 174, 176 receive engaging arms 182, 184, 186, 188 of the mounts 178, 180.

The arms 182, 184 of mount 178 join at the bottom 190 to form a U-shape about an aperture 194. Therefore, the terminal end 174 is secured in place and against rotation in the aperture 194 of the mount 178 by the arms 182, 184 being within the slots 110, 112 of terminal end 174 and the terminal end 174 resting against the bottom 190 of the U-shape. The arms 186, 188 of mount 180 join at the bottom 192 to form a U-shape about an aperture 196. Therefore, the terminal end 176 is secured in place and against rotation in the aperture 196 by the arms 186, 188 within the slots 110, 112 of terminal end 176 and the terminal end 176 resting against the bottom 192 of the U-shape. The apertures 194, 196 have a top side that is open as shown in FIG. 9.

Each of the mounts 178, 180 further comprise a top arm 200, 202, a vertical arm 204, 206, and an angled arm 208, 210. The top arm connects to the vertical arm, the vertical arm connects to the angled arm, and the angled arm connects to the engaging arms as shown in FIGS. 8 and 9. The top arms 200, 202 comprises slots 212, 214, 216, 218 at opposite ends. Fasteners, such as bolts 101 and nuts or the like, fix the mounts of the return idler assembly to the rails 26, 28 of the conveyor 10, and in particular to the bottom side of the rails. The head of the bolts 101 bear against the rail 26, the shank of the bolt extends through the respective rail 26, 28 through the respective slots 212, 214, 216, 218 and a nut (not shown) is threaded onto the shank. The nut bears against the portion of the top arm 200, 202 on opposite sides of the respective slot 212, 214, 216, 218.

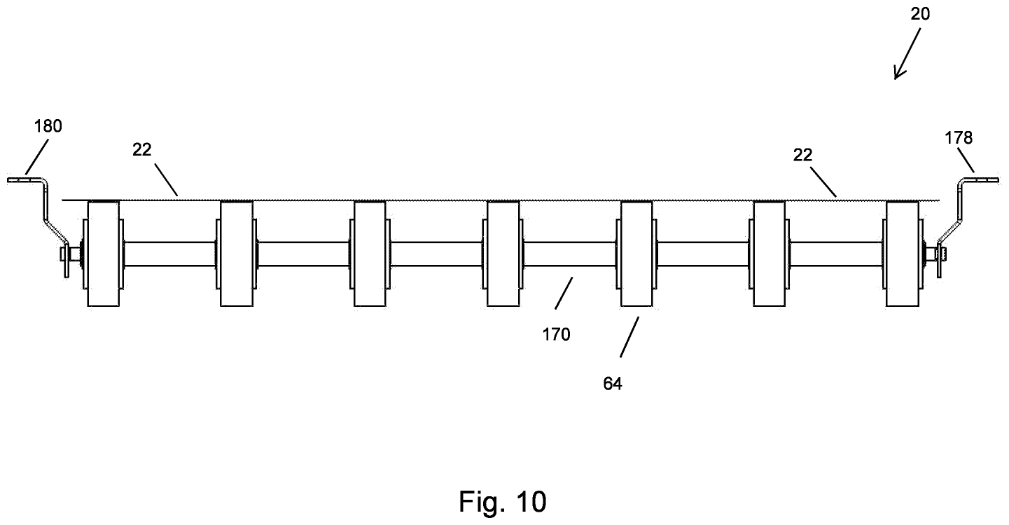

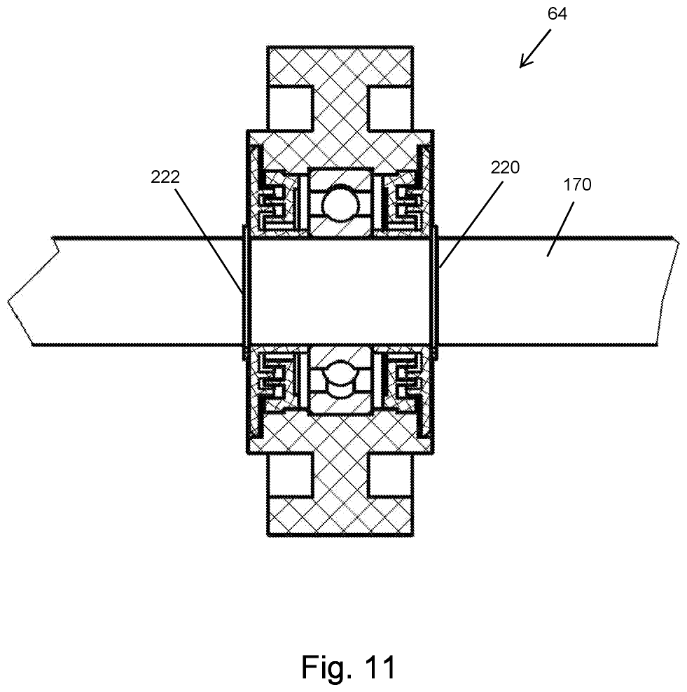

FIG. 11 shows a wheel 64 mounted to the axle 170. The wheel is laterally secured on the axle 170 by retaining rings or clips 220, 222. The clips are received in circumferential grooves (not shown) in the axle at the locations of the clips. In some embodiments, the clips are c-shaped clips. The clips 220, 222 contact or are adjacent the outer seals 140, 142 of the wheel 64 adjacent the axle 170 as shown in FIG. 11. FIG. 10 shows the belt 22 on the return idler assembly 20 being supported by the wheels 64. In some embodiments, the wheels are spaced apart equally along the axle 170 of the assembly 20, as shown in FIGS. 8 to 10.

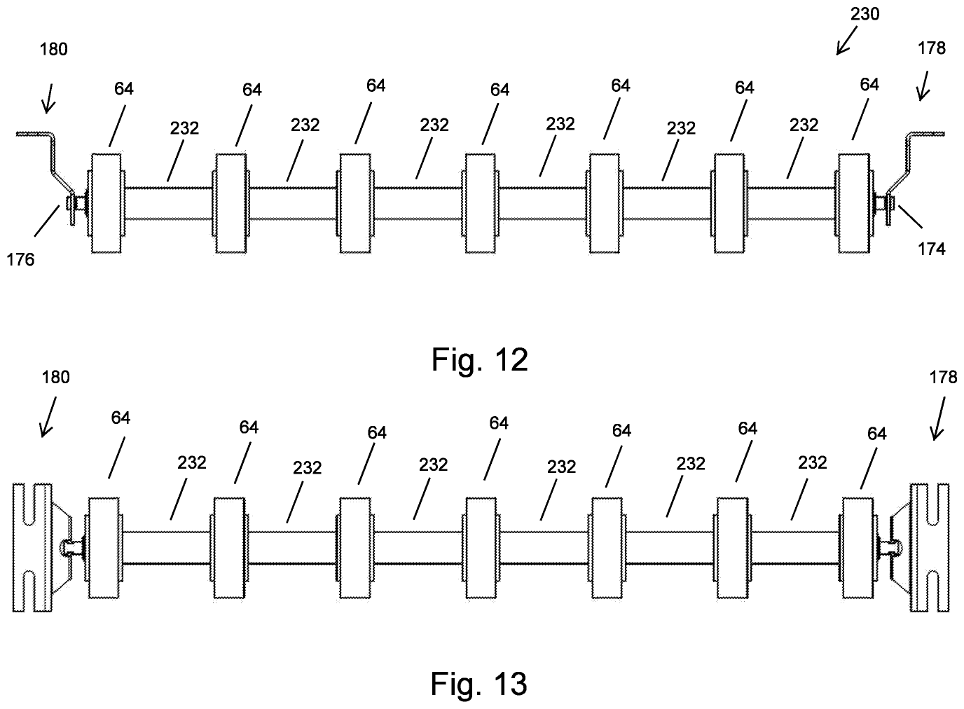

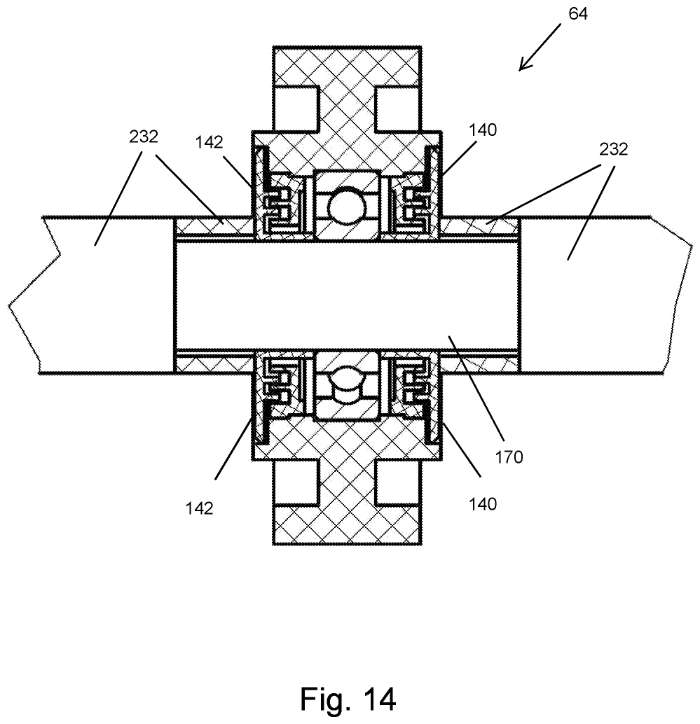

FIGS. 12 and 13 show a second embodiment return idler assembly 230. The assembly 230 is the same as assembly 20 except that instead of using clips 220, 222 to hold the wheels in laterally place along the axles 170, spacers 232 are positioned between the wheels to hold the wheels in place along the axles 170. Each of the wheels 64 rotates independently of the other wheels on and about the axle 170. The spacers are interspaced between the wheels. Therefore, except for the outer end wheels, each wheel has a spacer 232 on each of opposite sides of the wheel. The axle 170 is co-axial with the spacers. The spacers 232 contact or are adjacent the outer seals 140, 142 of the wheel 64 adjacent the axle 170 as shown in FIG. 13. End clips, such as c-shaped clips 220, 222 may be used on the outside of each of the outer end wheels before the terminal ends 174, 176 of the axle to retain the outside sides of those wheels on the axle and from the terminal ends. The clips may be received in outer grooves (not shown) in the axle. In some embodiments, the wheels 64 are spaced apart equally along the axle 170 of the corresponding assembly 20, 230, as shown in FIGS. 8 to 10, and 12 to 13.

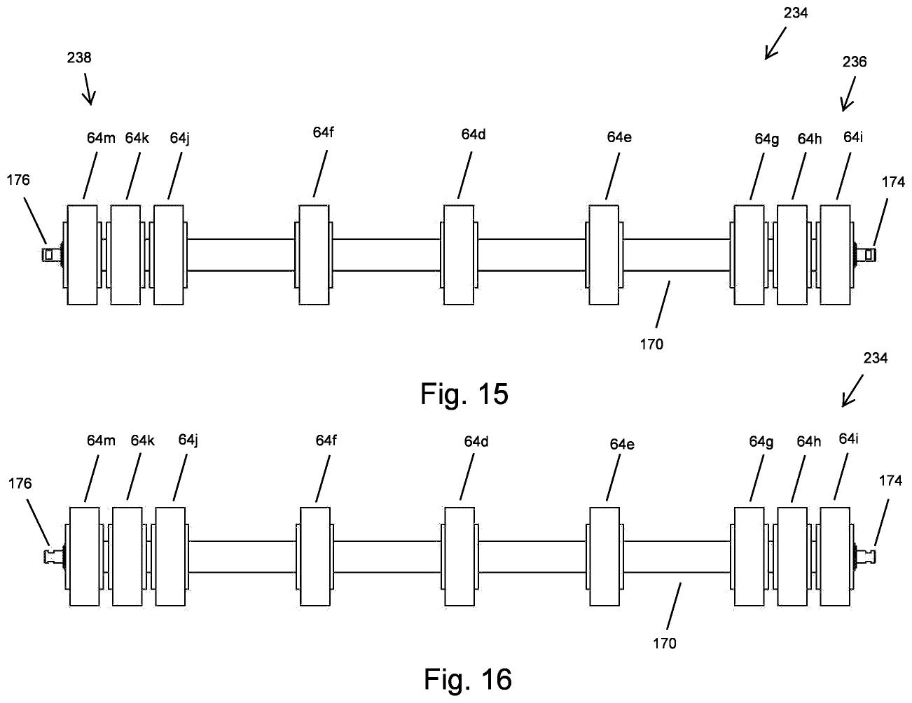

FIGS. 15 and 16 show a third embodiment return idler assembly 234. The assembly 234 is the same as assembly 20 except that the wheels are spaced apart differently along the axle 170 as compared to the wheel spacing of assembly 20. The assembly 234 comprises or is used with brackets 178, 180, but the brackets are not shown in FIGS. 15 and 16. Each of the wheels 64d, 64e, 64f, 64g, 64h, 64i, 64j, 64k, 64m are the same as wheel 64 but are labeled with a letter suffixes for ease of location identification in FIGS. 15 and 16. Assembly 234 comprises at least one outside pair of wheels, such as wheel pairs (64g, 64h), (64h, 64i), (64g, 64i), (64j, 64k), (64k, 64m), or (64j, 64m), at an end 236, 238, respectively, of the axle, where the wheels of the pair of wheels is spaced closer to each other as compared to the spacing or distance between at least one other pair of wheels of the assembly, such as pairs (64g, 64e), (64e, 64d), (64d, 64f), and/or (64f, 64j).

In some embodiments, assembly 234 comprises two outside pairs of wheels, such as a first pair of wheels (64g, 64h), (64h, 64i), or (64g, 64i), and a second pair of wheels (64j, 64k), (64k, 64m), or (64j, 64m), at ends 236, 238, respectively, of the axle 170, where each pair comprises wheels spaced closer to each other as compared to the spacing or distance between at least one other pair of wheels of the assembly, such as (64g, 64e), (64e, 64d), (64d, 64f), and/or (64f, 64j).

In some embodiments, wheels 64g, 64e, 64d, 64f, 64j are spaced apart equally from each other. In some embodiments, a first pair of outside wheels, such as (64g, 64h), (64h, 64i), or (64g, 64i) has a wheel spacing that is the same as the spacing of the wheels of a second pair of outside wheels such as (64j, 64k), (64k, 64m), or (64j, 64m).

In some embodiments, assembly 234 comprises one or two or more outside triplicates of wheels, such as a first triplicate (64g, 64h, 64i) and a second triplicate (64j, 64k, 64m) at ends 236, 238, respectively, of the axle 170, where the triplicate comprises wheels spaced closer to each other as compared to the spacing or distance between at least one other pair of wheels of the assembly, such as pairs (64g, 64e), (64e, 64d), (64d, 64f), and/or (64f, 64j).

In some embodiments, the first triplicate (64g, 64h, 64i) has a wheel spacing that is the same as the spacing of the wheels of the second triplicate (64j, 64k, 64m). In some embodiments, each of the wheels of the first triplicate are spaced equally apart. In some embodiments, each of the wheels of the second triplicate are spaced equally apart.

While FIGS. 15 and 16 show three wheels spaced closer at the ends of the axles, in some embodiments only two wheels are spaced closer at each end 236, 238. In some embodiments, more three wheels are closer spaced at one or both ends 236, 238. In some embodiments, the distance between adjacent closer spaced wheels (64g, 64h, 64i), (64j, 64k, 64m) of a pair or triplicate is 69 mm center-to-center or 22 mm from adjacent sides of the wheels. In some embodiments, the distance between adjacent further spaced wheels (64j, 64f, 64d, 64e, 64g) is 233 mm center-to-center or 186 mm between adjacent sides of the wheels. However, other distances can be used according to the needs or desires for a given application. One advantage to providing wheels spaced closer together at one or both ends 236, 238 of the axle 170, is that the wheels provide additional support to the lateral side portions of the belt. Spacers 232 and/or clips 220, 222 can be used to secure the wheels 64d, 64e, 64f, 64g, 64h, 64i, 64j, 64k, 64m of assembly 234 in place along the axle 170 in the same manner as described for assemblies 20, 230.

Some of the non-limiting benefits and/or features of at least some embodiment(s) of the conveyor and/or idler assemblies disclosed herein comprise the following.

The use of additional wheels and wheel bearings can increase the bulk material loads or weight that can be carried on the belt and by the conveyor. If one wheel 64 seizes and stops rotating, for example due to a bearing failure, the adjacent wheel(s) can carry the load of the belt and material on the belt.

Depending on the material selected for the tire of the wheel 64, when the wheel is seized due to bearing failure, the wheel may be worn down by the friction of the belt to the point where the seized wheel loses contact with the belt and the belt is supported by adjacent non-seized wheels therefore avoiding destruction of the belt. The idler assemblies better handle conveyor belts in the area of a curve or turn in the conveyor path by more easily allowing an outer portion of the conveyor belt to move faster than an inner portion of the belt due to the wheels independently engaging the belt, and thereby reducing the likelihood of the belt coming off of the conveyor. The wheel 64 width may provide a belt engaging surface with less area for debris and material to accumulate on a given wheel. This may reduce the likelihood that uneven debris/material buildup on the wheel would cause lateral diversion or mis-training of the belt from its normal operating location.

With respect to the troughing idler assemblies, more control over the belt can be provided by the wheels, including at the lateral edges of the belt, therefore allowing the belt to carry higher capacity or volume of bulk material and deterring or preventing bulk material from spilling off the lateral side(s) of the belt. Further, wheels present shorter lengths or tangents to the belt surface or a desired curve, and provide additional options for the trough shape or depth, which may include a closer approximate to a desired curve or arc.

If a wheel 64 fails or a wheel bearing fails and the wheel seizes from rotating, only one wheel or wheel bearing may need to be replaced representing a smaller portion of the overall idler assembly. Therefore, the repair costs and complexity may be reduced in at least some embodiments.

From the foregoing, it will be observed that numerous variations and modifications may be affected without departing from the spirit and scope of the invention. It is to be understood that no limitation with respect to the specific apparatus illustrated herein is intended or should be inferred. For example, one or more component embodiments may be combined, modified, removed, or supplemented to form further embodiments within the scope of the invention. Further, steps could be added or removed from the processes described. Therefore, other embodiments and implementations are within the scope of the invention.

The invention claimed is:

1. A troughing idler assembly for a bulk material belt conveyor, comprising:
a frame;
at least four axles mounted to the frame, each of the axles extending in a common plane;
at least four wheels, each of the wheels comprising a wheel bearing, each of the wheels mounted to a corresponding one of the axles; and,
the wheels are arranged in a trough configuration where at least two outer wheels of the at least four wheels are positioned vertically higher than at least one inner wheel of the at least four wheels.

2. The assembly of claim 1, wherein the frame comprises a plurality of posts, each of the axles is mounted to a pair of the plurality of posts.

3. The assembly of claim 2, wherein each of the plurality of posts comprises a first leg, a second leg, and a top leg connecting the first leg and the second leg; the first leg, the second, and the top leg each comprising an aperture for receiving an axle of the at least four axles.

4. The assembly of claim 2, wherein the frame comprises an arc member, a base member, and a one or more connecting members connecting the arc member to the base member, the plurality of posts are mounted to the arc member.

5. The assembly of claim 4, wherein the arc member has a plurality of feet for connecting to a conveyor frame of the bulk material belt conveyor.

6. The assembly of claim 1, wherein each of the wheels comprise an inner labyrinth seal, an outer labyrinth seal, and a tire.

7. The assembly of claim 6, wherein the tire comprises nylon.

8. The assembly of claim 1, wherein each of the wheel bearings comprise an outer race, an inner race, and a plurality of balls between the outer race and the inner race.

9. The assembly of claim 1, wherein the wheels are arranged along a trough arc that extends in a range of about 40 degrees and about 100 degrees.

10. The assembly of claim 1, wherein the at least four wheels comprises at least five wheels.

11. The assembly of claim 1, wherein each axle comprises a first terminal end and a second terminal end, for at least three axles of the at least four axles the first terminal end that is further from a center of the frame is positioned vertically higher than the second terminal end that is closer to the center.

12. The assembly of claim 1, wherein
the at least four wheels comprises at least five wheels;
the at least four axles comprises at least five axles;
the frame comprises a plurality of posts, each of the axles is mounted to a pair of the plurality of posts;
the wheels are arranged along a trough arc that extends in a range of about 40 degrees and about 100 degrees; and,
each axle comprises a first terminal end and a second terminal end, for at least four axles of the at least five axles the first terminal end that is further from a center of the frame is positioned vertically higher than the second terminal end that is closer to the center.

13. A return idler assembly for a bulk material belt conveyor, comprising:
an axle;
a plurality of wheels, each of the plurality of wheels aligned co-axially, comprising a bearing, and mounted to rotate independently on the axle; and,
a first pair of wheels of the plurality of wheels at a first end of the axle are spaced closer together than an at least one other pair of wheels of the plurality of wheels.

14. The assembly of claim 13, comprising a plurality of retaining clips fixing the plurality of wheels in position along the axle.

15. The assembly of claim 13, comprising a plurality of spacers interspaced between the plurality of wheels to hold the plurality of wheels position along the axle.

16. The assembly of claim 13, comprising a second pair of wheels of the plurality of wheels at a second end of the axle that are spaced closer together on the axle than the at least one other pair of wheels of the plurality of wheels.

17. The assembly of claim 16, wherein the first pair of wheels is a first triplicate of wheels, and the wheels of the first triplicate of wheels are spaced closer together than the at least one other pair of wheels; and the second pair of wheels is a second triplicate of wheels, and the wheels of the second triplicate of wheels are spaced closer together than the at least one other pair of wheels.

18. A bulk material belt conveyor, comprising:
a belt;
a troughing idler assembly, comprising
a trough frame,
at least four first axles mounted to the trough frame, each of the first axles extending in in at least one plane transverse to the belt,
at least four first wheels, each of the first wheels comprising a wheel bearing, each of the first wheels mounted to a corresponding one of the first axles, and,
the first wheels are arranged in a trough configuration where at least two outer first wheels of the at least four first wheels are positioned vertically higher than at least one inner first wheel of the at least four first wheels;
a return idler assembly, comprising
a second axle,
a second plurality of wheels, each of the second plurality of wheels aligned co-axially, comprising a second bearing, and mounted to rotate independently on the second axle;
a conveyor frame; and,
the troughing idler assembly and the return idler assembly are mounted to the conveyor frame, the troughing idler assembly mounted above the return idler assembly; and,
the belt supported on the at least four first wheels of troughing idler assembly and the second plurality of wheels of the return idler assembly.

19. The conveyor of claim 18, wherein the trough frame comprises a plurality of posts, an arc member, a base member, and a one or more connecting members connecting the arc member to the base member, each of the first axles is mounted to a pair of the plurality of posts, the plurality of posts are mounted to the arc member; and the wheels are arranged along a trough arc that extends in a range of about 40 degrees and about 100 degrees.

20. The conveyor of claim 18, wherein
the at least four first wheels comprises at least five first wheels;
the at least four first axles comprises at least five first axles;
the trough frame comprises a plurality of posts, each of the first axles is mounted to a pair of the plurality of posts;
the first wheels are arranged along a trough arc that extends in a range of about 40 degrees and about 100 degrees; and,
each first axle comprises a first terminal end and a second terminal end, for at least four first axles of the at least five first axles the first terminal end that is further from a center of the trough frame is positioned vertically higher than the second terminal end that is closer to the center.
